(19) United States
(12) Patent Application Publication
(10) Pub. No.: US 2004/0172374 A1
(43) Pub. Date: Sep. 2, 2004

(54) Predictive data mining process analysis and tool

(76) Inventor: George Henry Forman, Port Orchard, WA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/377,447

(22) Filed: Feb. 28, 2003

(51) Int. Cl. G06F 15/18; G06F 7/60; G06F 17/10

(52) U.S. Cl. 706/12

(57) ABSTRACT

In predictive data mining, a process and tool presents a method to compare given competing algorithms to a derived reference, such as a baseline or benchmark. A result confidence as to the suitability of the competing algorithm to a given task is generated. In an exemplary embodiment, a randomized feature acting, simple, algorithm is used to generate the baseline. In an alternative embodiment, the process and tool is used to determine learnability of the given task. A mechanism to account for overfitting of data is described.

### BACKGROUND

1. Technology Field

The disclosure relates generally to the field of data mining.

2. Description of Related Art

Data mining is a process that uses computerized data analysis tools to discover data patterns and relationships that may be used to reach meaningful conclusions and to make predictions, generally associated with a predetermined business issue, e.g., “What is the largest segment of target audience for this specific magazine with respect to my product?”; “What is the effectiveness of this specific drug on geriatric patients?”; and the like. The objective of data mining is to produce from given data some new knowledge that the user can then act upon. Data mining does this by modeling for the real world based on data collected from a variety of sources; these databases can be huge and unwieldy from a human analysis perspective.

Predictive relationships found via data mining are not necessarily causes of an action or behavior, but may confirm empirical observations and may find from the data itself new, subtle patterns that may yield steady incremental improvements with respect to the business task-at-hand. In other words, data mining describes patterns and relationships in a particular database. Traditionally, the model built may then be verified in the real world via empirical testing. Thus, data mining is a valuable tool for increasing the productivity of users who are trying to build predictive models from their data, via a chosen type of prediction such as either classification—predicting into what category or class a case falls—or regression—predicting what number value a variable will have. Generally, the predictive data mining process steps are to: (1) define a business problem, (2) build a database, (3) explore and understand the data, (4) prepare the data for modeling, (5) build the model, (6) evaluate the model, and (7) deploy the model and results.

There are many known data mining algorithms and concomitant models—e.g., neural networks, decision trees, multivariate adaptive regression splines, rule induction, K-nearest neighbor and memory-based reasoning, logistic regression, discriminant analysis generalized additive models, and the like—and associated optimization tools—e.g., boosting, genetic algorithms, and the like. In essence, in the real world, the nearly infinite variety of business goals and associated collected data present ever-changing problem sets where, at least at the outset, there is presented a task of unknown difficulty. Thus, there is a market for specialized, highly accurate predictive data mining products.

Because the process derives results from use of the given data itself, it is therefore inductive. Inherently, the algorithms vary in their sensitivity to data issues. Predictive models are built using a learning algorithm on a given training dataset, data for which the value of the response variable is already known, so that calculated or estimated values can be compared with the known results. A model is in essence a specialized form of the general learning algorithm; the model is the learning algorithm instantiated with training data. The process for developing a model generally is to give the algorithm a test set of data, known as the training set, where the outcome is already known, and to find the accuracy—or other known in the art applicable characteristic, such as precision, recall, F-measure, mean— squared error, and the like—as is appropriate to the task. The data mining researcher, once having formulated the issue—e.g., a predetermined business goal—selects an appropriate database to be explored and, hopefully, a best data mining algorithm available for the task; where, for the purpose of describing embodiments of the present invention, “best” as used hereinafter generally means that with a given, limited, training dataset, and limited number of learning algorithms employed thereon, in comparison of the results, one of the algorithms scores the highest—i.e., is the “winner”—and therefore is the apparent, or the currently, empirically, “best” algorithm for building the “best” model. Thus, in order to build a best model in view of the given problem and relational dataset, the practitioner may apply a proffered algorithm alleged to be suited to the problem or may often apply a variety of algorithms to the database and then select such an apparent best. A great deal of supervised machine learning research and industrial practice follows a pattern of trying a number of classification algorithms on a dataset and then selecting and promoting the algorithm(s) that performed best according to cross-validation, or “held-out,” training data test sets. The best scoring of the various applied algorithms is then selected for mining the database, as it should be the best to the business issue-at-hand.

Software vendors and their researchers and developers compete vigorously to develop new, more accurate algorithms. The choices made in setting up a new data mining process, and related optimizations, will affect the accuracy and speed of the models. Beyond empirical verification, the question is how to determine the relevancy of an applied data mining algorithm. In other words, if a specific algorithm is applied and found to achieve an apparently good score, for example, eighty-five relative to a perfect score of one hundred—or by some similar comparison of derived quantifiers—whether that is in reality a significant result or not.

The term “tool” used herein is used as a synonym for any form of algorithm, software, firmware, utility or application computer program, or the like, which can be implemented in either an industry standard, de facto industry standard, or proprietary computer language, or the like. No limitation, inherent or otherwise, on the scope of the invention is intended by the inventor, nor should any be implied therefrom.

### BRIEF SUMMARY

The basic aspects of the invention generally provide for a predictive data mining process analysis process and tool.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIGS. 1A, 1B and 1C are graphical depictions in which:

FIG. 1A is a graph illustrating a first comparison between learning algorithm score distributions in a first exemplary result via application of an exemplary embodiment of the present invention,

FIG. 1B is a graph illustrating a second comparison between learning algorithm score distributions in a second exemplary result via application of an exemplary embodiment of the present invention, and

FIG. 1C is a graph illustrating a third comparison between learning algorithm score distributions in a third exemplary result via application of an exemplary embodiment of the present invention.

FIG. 2A is a schematic diagram in accordance with an exemplary embodiment of the present invention in which the first, second and third exemplary results as shown in FIGS. 1A-1C are derived.

FIG. 2B is a process chart in accordance with the embodiment as shown in FIG. 2A.

Like reference designations represent like features throughout the drawings; numerals using “prime” symbols are provided to identify like, though not necessarily identical, elements between drawings. The drawings in this specification should be understood as not being drawn to scale unless specifically annotated as such.

### DETAILED DESCRIPTION

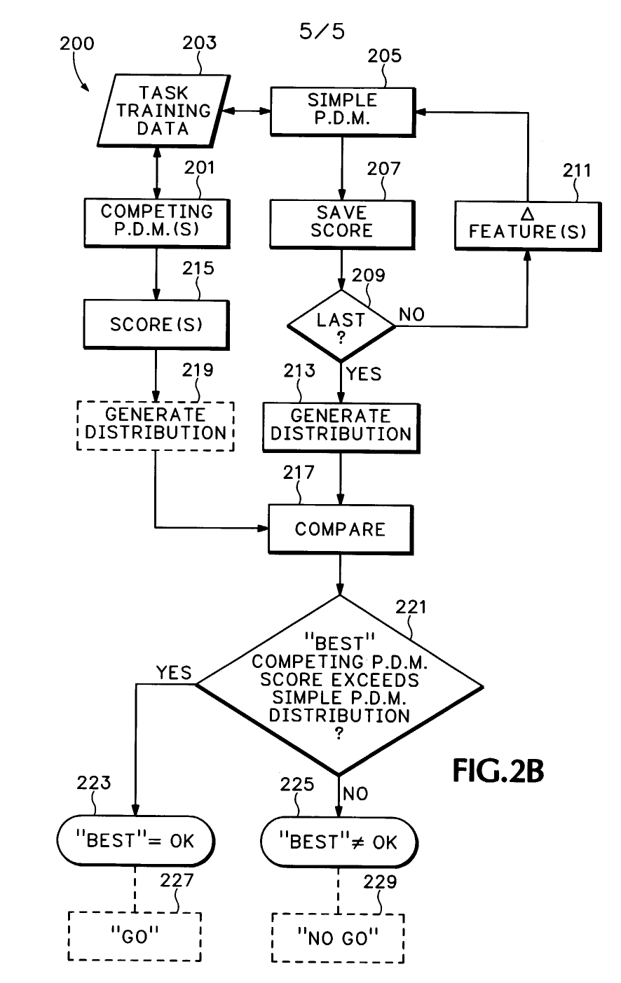

Throughout this Description, it may be beneficial to refer to FIG. 2A as demonstrating an overall view of an exemplary embodiment of the process, or tool, 200′ of the present invention. Assume a predetermined data mining task, “Task 1.” For a given dataset 203′ and looking for the best data mining model to apply in view of a predetermined objective goal, one or more learning algorithms 201′, 205′ are trained and applied to the dataset. Let schematically illustrated learning processes “A₁” through “A₁₊ₙ”—where “n” is a generally a relatively small number, e.g. as shown “4,” indicative of one or more proffered algorithms believed to be applicable to Task 1—represent the competing learning algorithms from which one will emerge as the best for modeling Task 1. Each is applied to the dataset 203′ and achieves a score, or other quantifier, appropriately predetermined by the researcher for the given task (see Background section hereinabove). One of these algorithms 201′ will achieve the highest score, e.g. a relative 84%, and be the selected winner 201″. Note that when a plurality of competing learning algorithms is used, a distribution—e.g., illustrated bell curve “S(A)” 219′—can be derived. Alternatively, it should be recognized that in a real world situation, there may be only one proffered algorithm, e.g., a vendor touting their product as specialized and suited to Task 1. The “winning score”—e.g., 84%—in this instance is simply the score that the vendor's product achieves. Based upon the given task dataset 203′, a researcher may also have, or a computer may quickly derive from the given task and data, a predetermined estimated score as a random, or majority, guess (in a simple example, if the only choices are “Heads” or “Tails,” a 50% accuracy for any caller is the appropriate predetermined estimated score), shown in FIG. 2A as element 202. This is used for deciding whether the competing algorithms 201′ or the “winner” 201″ is no better than random guessing. More pointedly, with respect to FIG. 2A if the median score of the bell curve 219′ S(A) is found to be no better than the given random guess value, none of the competing models is likely suited to the task or the features chosen are not predictive for the task.

For comparison, a known, simple algorithm—e.g., naive-Bayes, Chi-squared Automatic Interaction Detection, or the like known-in-the-art, rudimentary, classifier algorithms—is used in conjunction with a randomized generator 211′ (described in more detail hereinbelow) to create a large variety of simple algorithms applicable to the task, shown in FIG. 2A as elements 205′, “B₁” through “Bₘ” where “m” is a relatively large number, e.g., “500” As with the competing algorithms 201′, A₁-A₁₊ₙ, a distribution 213′ of scores “S(B)” can be derived from the operations of the simple algorithms 205′ on the dataset 203′. Description of more specific examples will now be instructive to understanding the present invention.

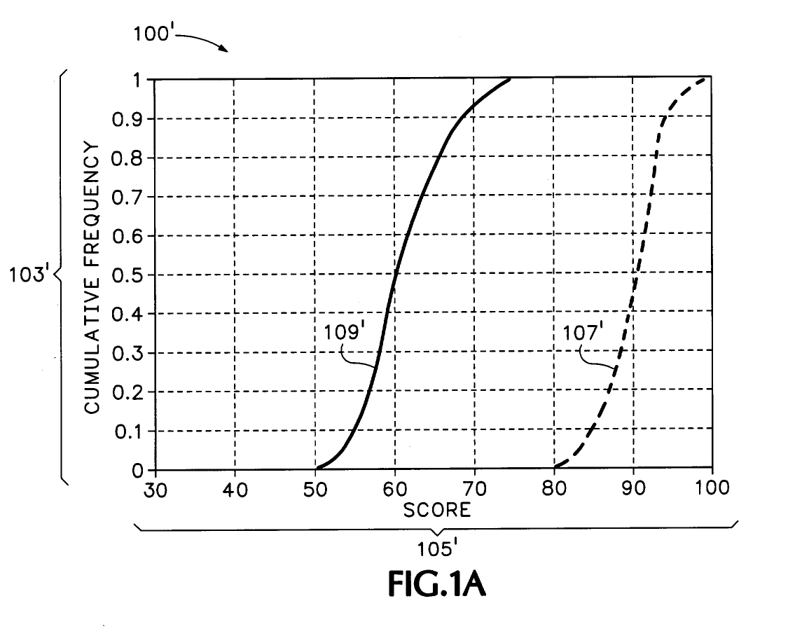

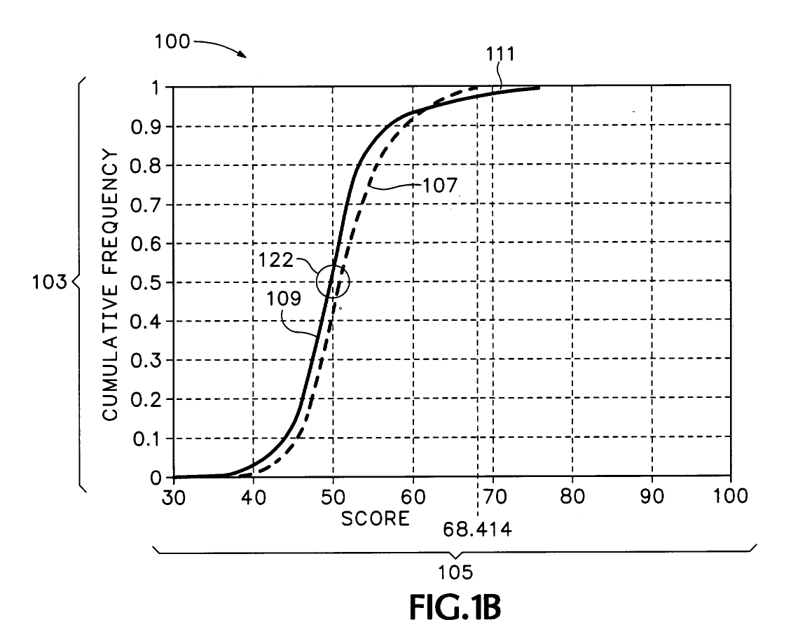

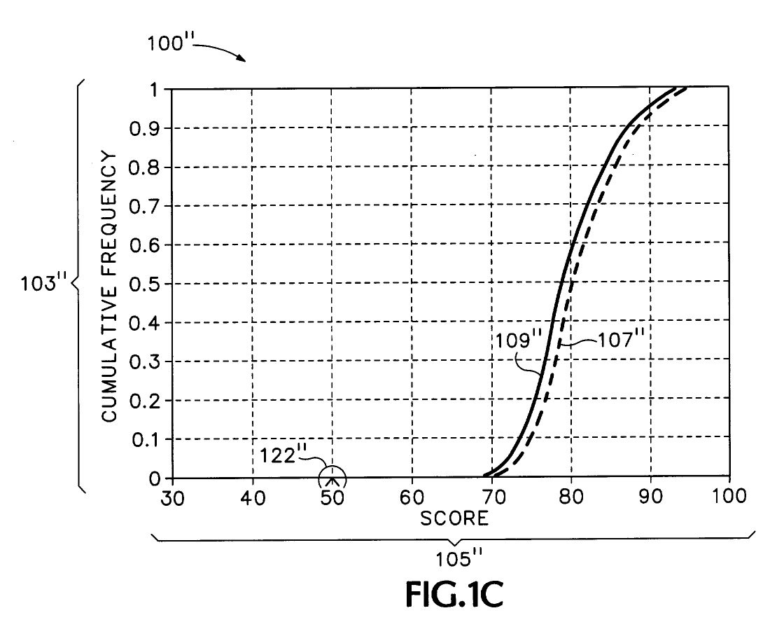

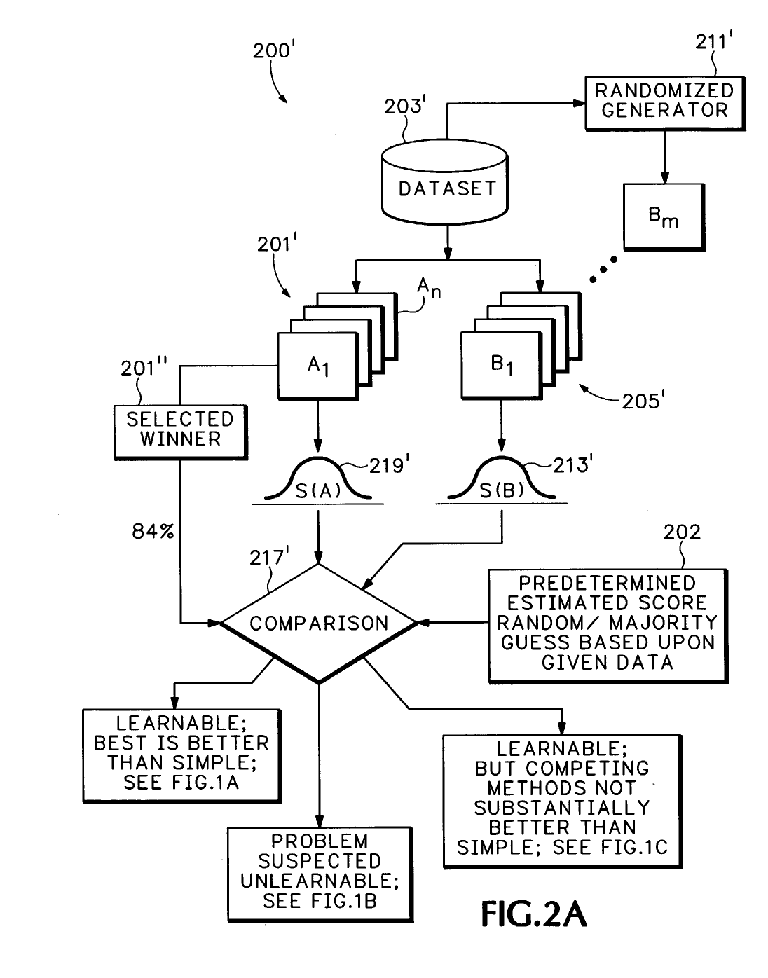

Turning now also to FIG. 1B, there is shown a graph 100 in the form of a cumulative distributions of a plurality of scores. The vertical axis 103 is the normalized “Cumulative Frequency;” the horizontal axis is the “Score.” A cumulative distribution point, e.g. at x=60, y=0.90, means that “y” of the methods scored less than or equal to “x,” e.g., 90% of the methods scored worse than 60%. A first curve 107, “Distribution of Prediction Accuracy Scores for Task 1,” represents actual results from one hundred fourteen applications of competing classifier algorithms to a task of binary classification of a genomic dataset having 139,351 binary features, with a training set of 1909 cases—42 being positive, the remainder negative—and with a test set from a somewhat different distribution: a set of 634 chemical compounds predicted by chemists to be active in binding (positive class) after they had analyzed the training set. Note that this is analogous to a distribution such as bell curve 219′ of FIG. 2A. Each was scored by the average of their true positive rate and true negative rate. As illustrated in the graph, the best competing classifier algorithm had a score of 68.444. From a test standpoint, one would then assume that a model generated using that best competing classifier algorithm would be validated as working as intended, that is, this trained classifier is useful as a model for making good predictions and may be used with a relatively high confidence of validity to the given Task 1. In accordance with the present invention, this is shown to be a false assumption

On the same data, a test was performed to generate scores for approximately 3500 randomly generated—that is, each using randomly selected features of the dataset—naive-Bayes classifiers. Using the same scoring metric, a second cumulative distribution of scores was generated and is shown in FIG. 1B as curve 109, “Randomly Generated Bayes Classifier Scores,” derived from those scores generated using four randomly selected features of the Task 1 dataset in each run. As is clearly demonstrated, the curves 107, 109 are a very close match. In other words, the whole collection of competing methods performed about as well as the whole collection of randomized simple methods. Seeing this information, one esteems the competing models with only low credibility or validity. The median shown as region 122 of the one-hundred and fourteen applied classifier programs performed only as well as random guessing, which achieves a score of 50 for this task. This fact suggests that the models tried are not able to effectively learn the target concept, perhaps due to a lack of predictive features. There are naturally some that scored somewhat better or somewhat worse than random guessing. Finally, the indicated “apparent best” algorithm for Task 1 was actually worse than the best of the simple classifiers, undermining its validity as a useful technique for this problem. Experimentally, this result was verified by repeating the analysis, generating trivial classifiers that worked from a single randomly chosen binary feature; this resulted in an S-curve with the same median score, but with a slightly steeper slope as one might expect from the simpler decision function.

In accordance with an exemplary embodiment of the present invention, now also illustrated by FIG. 2B, a process and tool 200 for determining whether one or more given learning algorithm(s) is the suitable for a given task is demonstrable. In the main, once a proffered, or best competing predictive data mining (“PDM”) algorithm 201 has been selected based on its score on the given dataset, a comparison of its performance is obtained. Thus, to evaluate one or more such competing PDM algorithms 201, an appropriate reference, such as a baseline, or benchmark, needs to be established.

The task data 203 is used with a simple, e.g., naive-Bayes, PDM algorithm 205 to generate a relatively large number of distribution analysis scores, e.g., one thousand (1000) generated, randomized models; it may be empirically estimated as to the actual number of benchmark tests that should be generated based upon the user's knowledge of the type of task data under consideration, the most appropriate type of modeling related to the goal-at-hand, and the like factors as would be known to those skilled in the art. To do this simple PDM algorithm modeling, the task data 203 training set is run through the simple PDM algorithm 205 using a predetermined number of features, randomly selected during each sequential run. For each of the simple PDM algorithm 205 runs using the randomly selected features for each run, its performance, or score, is measured using whatever scoring metric is appropriate for the project goal, e.g., accuracy, precision, recall, F-measure, cost-sensitive evaluation, area under a Receiver Operating Characteristic (ROC) curve, or the like as is known in the art. Each score is saved 207. If the run is not the last 209, NO-path, other features are selected randomly 211, and the simple PDM algorithm 205 re-run. The process and tool 200 loops as shown in the process chart until the appropriate, predetermined number of scores are obtained. Compared to running a competing PDM algorithm, the time for obtaining a score from such a simple PDM algorithm is generally negligible. From these scores, a distribution is generated 213 (see also, e.g., FIG. 2A, 213′). Referring also, for example, to FIG. 1A-1C, a cumulative distribution curve 109′, 109, 109″, respectively, may be generated for the scores achieved using the simple PDM model variants that were generated. Note that traditional bell curves, histograms, or the like as used by those skilled in the art, may be employed, demonstrating a distribution of scores accordingly.

The task data 203 is used with the at least one competing PDM algorithm 201. At least one score is thus obtained 215. A comparison is made 217; see also FIG. 2A, element 217′. In the simplest case, and one likely in an industrial context where the user is evaluating a particular competing PDM algorithm offered by a vendor as being best suited to the problematical business task-at-hand, a single score will show up as a point relative to the distribution curve 213; further runs, generating more points for comparison, may be made. Alternatively, referring again, to FIG. 1B, where a number (114) of competing PDM algorithms are under consideration, a comparable distribution curve 107 may be generated, accordingly illustrated in phantom- -line in FIG. 2B.

The comparison 217, 217′ is straightforward. If the competing PMD algorithm 201 score, multiple scores, or distribution, is in truth suited to data mining the dataset 203, their score(s), or relative distribution, will be shifted significantly to the right of the randomized, simple PDM algorithm curve. This result is illustrated by FIG. 1A, graph 100′, where cumulative frequency 103′ is plotted against score 105′ and where distribution 109′ represents the scores generated by a randomized, simple learning algorithm and distribution 107′ represents scores generated by allegedly suited competing PDM algorithms. That is, if the score 215, or distribution 219, 219′ from the competing PDM algorithm 201 is better than the simple PDM algorithm 205, 205′ distribution 213, 213′, the competing algorithm passes scrutiny, 221, YES-path, 225; if not, 221, NO-path, it fails 225.

For example with respect to FIG. 1B again, the competing algorithm curve 107, again “Distribution of Prediction Accuracy Scores for Task 1” is only barely to the right of the curve 109, again “Randomly Generated Bayes Classifier Scores,” neither scoring higher than about 74. Thus, the process and tool 200 shows that for the given data and task-at-hand, the competing algorithms 201 generally are no better than the simple algorithms 205. In other words, the user can eliminate the algorithm(s) thus tested as having failed to provide confidence in validity, or marginal value over simple algorithms, for the task-at-hand. Again, note that the median scores are at about the score achieved by random guessing behavior—i.e., 50 for this task—which indicates that the task as given with the existing dataset is not learnable by the algorithms tried.

In another exemplary result, looking to FIG. 1C and graph 100″ where cumulative frequency 103″ is plotted against score 105″, in this comparison of distribution, the scores 107″ generated by the competing PDM algorithms are only barely better than those scores 109″ achieved using a randomized simple PDM algorithm. However, all the scores range from about 70 to about 94. In this analysis, the competing algorithms may still be suitable for the task if the predetermined estimate 202 of score for majority guessing upon the given dataset 203′ was, for example, only 60.

Note that confidence scales, probabilities, and the like as would be known in the art using traditional statistical analysis can be developed for analyzing the resultant relationship between the competing algorithm(s) score(s) and the simple algorithm scores. For example, with respect to FIG. 2B step 221, such techniques could be used to generate a computerized “GO/NOGO” answer to the question of whether a proffered competing PDM algorithm is suitable for the task-at-hand. As illustrated in phantom- -line elements 227, 229 of FIG. 2B, if a “winning” score is greater than a maximum benchmark by e.g., 25% of the used parameter, the answer is GO 227 because the proffered competing PDM is suited; if the “winning” score is not, the answer is NO GO 229. In general, it has been found that if the test dataset has only a few positive or negative items, than the competing PDM may be suited if it achieves a score in approximately the 95^{th} percentile or better.

In alternative implementations, a randomized, different number of features can be selected for each run in order to generate the baseline. For example, in a text classification problem, fifty to one-thousand features may be available. But, if the domain problem has only a few, e.g., five, features available in total, and only one or two are selected in each run, many of the runs will yield identical results. Therefore, another source of simple random variation should be imposed. Another source of variation could be in a preliminary discretization of the data or in the use of different simple algorithms—using the same features, viz., the user's best guess as to most relevant, running different simple algorithms instead of 1000 naive-Bayes runs; however, it may be difficult to generate an adequate number of scores to derive an accurate baseline.

In analysis of the results of the comparison, another consideration may be made depending on the number of competing PDM algorithms under consideration. The percentage of randomized, simple PDM algorithms that exceeded the score of the competing PDM algorithm (see FIG. 1B, area 111) may be multiplied by the number of competing PDM algorithms under consideration. If the result is greater than one or two, consider the possibility that the performance of the best of those competing PDM algorithms can be explained by a null hypothesis that it is merely the leader of a set of poorly performing, mediocre, competing PDM algorithms. Such an alternative determination can also be worked into a computer program in a known manner.

Note that as a corollary to determining the validity of a predictive data mining model for a task, the present invention may also serve to discover when a classification problem appears nearly unlearnable. In some situations, the training set features are not predictive of the class variable or the training dataset may come from a very different distribution than the testing dataset. In the latter situation, if the chosen classifier matches the shape of the training set concept very precisely, then it will be sure not to match the deformed testing concept precisely. The best method based on the training set will ultimately result in unpredictable modeling performance. Predictive data mining researchers avoid such datasets, but in real-world industrial settings, nearly unlearnable tasks are regularly attempted. Where there is a diversity of attempted competing algorithms to compare to the randomized, simple, learning algorithms employed, like herein the exemplary naive-Bayes classifier, it is reasonable to rule out a scenario indicative of the attempted competing algorithms each merely being too specialized for the task where the researcher has selected similar methods, e.g., all neural network learning algorithms. Thus, diversity in the selection of competing algorithms obviates a potential misinterpretation of the results. The other inference which may be drawn then is that the task is nearly unlearnable from the definition thereof from the given training set using any of those attempted competing algorithms; again, this is a conclusion which may be drawn with respect to FIG. 1B.

When the scores from the competing PDM algorithms 201 do in fact fall to the left of the benchmark, the user may wish to consider that the training data 203 simply may have been overfit by the competing PDM algorithms, particularly the highest scoring one(s). It is therefore advisable that, particularly when only one competing PDM algorithm 201 is being evaluated with the present invention that more than one test run be assessed, e.g., by changing the number or types of features selected for mining or other methods as would be known to those skilled in the art. Moreover, then the competing PDM algorithm 201 provides more than one score which exceeds the benchmark, e.g., falls to the right of the baseline curve 109, such multiple assessments will also provide even greater confidence as to the validity of that algorithm for the data mining task-at-hand.

It is further contemplated that a business may be created for evaluating competing PDM algorithms thought to be suited to a given task-at-hand having an associated database. The service provided could include helping the owner of an enterprise with one or more of the preliminary (7)-steps as set forth in the Background section above, as well as the actual validation or disqualification of a given competing PDM software product being offered by a vendor to the enterprise, touting it as the latest, greatest product on the market for the issues facing the enterprise. Having run an extensive series of simple PMD algorithms on the enterprise's dataset-of-interest, providing a bell curve of results, the proffered product could be tested to find out where its score(s) fall on the curve, indicating whether it is indeed validated as substantially better than simple algorithm methods. It should be recognized that how close one is to the benchmark best is somewhat subjective and dependent upon the business goal. Therefore, no limitation on the invention is imposed as to, for example with respect to FIG. 1A, how far to the right the competing algorithm score distribution should be before it is deemed significantly better than the simple algorithm score distribution. It remains that not having a benchmark as provided in accordance with the exemplary embodiments of the present invention effectively leaves one in the dark as to the efficacy of the alleged best PDM product.

The described exemplary embodiments of the present invention provide a process and tool for evaluating one or more competing learning algorithms, including as to whether the algorithm is suited to the given database in view of business goal or other task-at-hand, whether the task is nearly unlearnable, and whether the best model has overfit the data.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

What is claimed is:

1. A process for determining suitability of at least one given learning algorithm for modeling a given task-relational dataset, the process comprising:
deriving a score from the algorithm operating on the dataset;
comparing said score to a reference determined from the same dataset; and
determining said suitability from said comparing.

2. The process as set forth in claim 1 comprising:
determining said reference from a large plurality of simple predictive data mining models derived from said dataset.

3. The process as set forth in claim 2, said determining said reference further comprising;
generating said models by randomly varying selected features of the dataset used by a simple learning algorithm.

4. The process as set forth in claim 2, said determining said reference further comprising:
operating on selected features of the dataset with a plurality of said simple learning algorithms.

5. The process as set forth in claim 2, said determining said reference further comprising:
generating said models by randomly varying the number of features of the dataset used by a simple learning algorithm.

6. The process as set forth in claim 1 wherein said determining said suitability is based on a relative position of said score with respect to said reference.

7. The process as set forth in claim 3 said comparing further comprising:
having more than one said given learning algorithm competing, comparing scores generated by each said given learning algorithm to said reference,
examining at least one relationship between said scores and said reference, and
when said relationship is substantially within a predetermined parameter, designating each said learning algorithm as no better than said models.

8. The process as set forth in claim 1 comprising:
if a median of a distribution of scores for more than one said given learning algorithm for a given task and a median of a distribution of scores for said reference lies within a predetermined closeness to a score achieved by random guessing for said task, designating said task as potentially unlearnable with respect to said more than one said given learning algorithm.

9. The process as set forth in claim 1, determining said reference further comprising:
iteratively operating a simple learning algorithm on a training set of said dataset associated with a predetermined task a predetermined number of times selected for establishing a relational number of scores wherein features of the training set of data are randomly selected for each iteration.

10. The process as set forth in claim 9 wherein said reference is formed by generating a distribution function of said relational number of scores.

11. The process as set forth in claim 10 wherein said function is perceptibly displayed and said display forms said reference for said comparing.

12. The process as set forth in claim 10 wherein said function is a measure for determining a marginal value from said learning algorithm score.

13. The process as set forth in claim 10, said determining further comprising:
overlaying said score with respect to said reference, and
verifying said suitability of the applicability of said algorithm to data mining with respect to said task based upon a result of said overlaying.

14. The method as set forth in claim 1 wherein said learning algorithm is related to a classification type task.

15. The method as set forth in claim 1 wherein said learning algorithm is related to a regression type task.

16. A tool for verification of at least one given predictive data mining program associated with a given problem having a representative database, comprising:
means for creating a verification benchmark from said representative database; and
means for comparing said benchmark to at least one score achieved using said program on said database wherein said comparing yields a result indicative of whether said program is suited to predictive data mining of said database.

17. The tool as set forth in claim 16, said means for creating comprising:
means for generating a diagrammable set of scores from said database using means for simple predictive data mining in a first real time which is substantially less than a second real time required for generating a single like score with said given predictive data mining program.

18. The tool as set forth in claim 16, said means for creating comprising:
means for iteratively running a random feature selection for the simple learning algorithm on said database.

19. The tool as set forth in claim 16, said means for creating comprising:
means for running a plurality of simple learning algorithms independently on training data associated with said database.

20. The tool as set forth in claim 16, said means for creating comprising:
means for generating a plurality of scores via simple predictive data mining operations, and
means for computing a distribution said scores.

21. The tool as set forth in claim 20, said means for comparing comprising:
means for analyzing said at least one score against said distribution, and
based on said analyzing, means for providing a resultant verification relationship between the score and the distribution.

22. The tool as set forth in claim 16 further comprising:
means for indicating a first distribution of first scores for a respective set of competing learning algorithms associated with said given problem, and
means for indicating a second distribution of second scoring scores for said means for creating a verification benchmark from said representative database.

23. The tool as set forth in claim 16 further comprising:
means for correlating said first distribution and said second distribution such that a relationship indicated therefrom is a measure of validity of each said algorithms with respect to said verification benchmark.

24. The tool as set forth in claim 23 said means for correlating further comprising:
means for determining if said given problem appears unlearnable by said algorithms.

25. The tool as set forth in claim 16 implemented as a computer program.

26. A method of doing business comprising:
creating at least one first quantifier for at least one given data mining algorithm on given data for a given problem;
creating second quantifiers on said given data by repeatedly applying at least one randomized, simple, data mining algorithm;
comparing said first quantifier with said second quantifiers; and
determining whether said given data mining algorithm is substantially better than said randomized, simple, data mining algorithm at data mining said given data with respect to said given problem.

27. The method as set forth in claim 26 further comprising:
creating a set of third quantifiers with respective non-simple data mining algorithms, and
comparing said third quantifiers with said first quantifier and said second quantifiers for determining if said given problem is in a potentially unlearnable category for the algorithms applied.

28. The method as set forth in claim 26 said creating at least one first quantifier further comprising:
receiving a plurality of competing data mining algorithms;
operating each of said competing data mining algorithms on said given data and deriving first scoring scores for each, respectively;
creating a first arrangement of said scores showing a first observed frequency of occurrence;
operating at least one simple data mining algorithm on said given data using at least one varying factor and deriving second scoring scores for each, respectively;
creating a second arrangement of said scores showing a second observed frequency of occurrence relatable to said first arrangement;
correlating said first arrangement and said second arrangement forming a single relational presentation; and
from said presentation, determining the suitability of said competing data mining algorithms for said task.

29. A computer memory comprising:
programmable code for comparing at least one first operating representative function of at least one competing learning algorithm operating on a given dataset to second operating representative functions of at least one simple learning algorithm operating on said dataset; and
programmable code for generating a relational presentation of said at least one first representative function and said second representative functions wherein relative positioning of said at least one first representative function with respect to said second representative functions is indicative of the ability of the competing learning algorithm's power to model said dataset compared to said simple learning algorithms power to model said dataset.

30. The memory as set forth in claim 29 comprising:
programmable code for operating a plurality of other competing learning algorithms on said dataset and generating at least one first representative function for each for determining learnability of a given problem related to said given dataset.

31. The memory as set forth in claim 29 wherein said one simple learning algorithm operates iteratively and variably on said dataset.
